(19) United States
(12) Patent Application Publication
(10) Pub. No.: US 2008/0212765 A1
(43) Pub. Date: Sep. 4, 2008

(54) Directory assistance with advertisement from category related to request category

(75) Inventors: Scott Wolmuth, Santa Rosa, CA (US); Scott A. Kliger, Franklin, MI (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Jingle Networks, Inc., Bedford, MA (US)

(21) Appl. No.: 11/981,520

(22) Filed: Oct. 31, 2007

Related U.S. Application Data
(63) Continuation-in-part of application No. 11/728,189, filed on Mar. 23, 2007.
Application No. 11/728,189 is a continuation of application No. 10/063,990, filed on May 31, 2002, now Pat. No. 7,212,615.

(51) Int. Cl. H04M 3/42

(52) U.S. Cl. 379/218.01

(57) ABSTRACT

The current invention is a system for providing telephone directory assistance service in which a telephone user calls to the system and the system will, based on the requested number or type of service, hear a recorded advertisement selected from a category related to the requested service. The advertisements are selected from a databank, which may include any number advertisements, according to selection criteria. After the advertising announcement is completed, the directory assistance call is processed as usual. The selection criteria can include the use of SIC codes.

### RELATED APPLICATION(S)

This application is a continuation in part of U.S. application Ser. No. 11/728,189, filed Mar. 23, 2007, which is a continuation of U.S. application Ser. No. 10/063,990, filed May 31, 2002, now issued as U.S. Pat. No. 7,212,615. The entire teachings of the above application(s) are incorporated herein by reference.

### BACKGROUND OF THE INVENTION

1. Field of the Invention

This invention relates to systems for providing telephone toll services such as, but not limited to, directory assistance or long-distance calling.

2. Description of Prior Art

The need for phone customers to locate the name, address and number of businesses such as airlines, floral shops and auto repair shops has been around for almost as long as the phone has been in existence.

Currently most phone systems charge extra for the look up of the names and addresses and numbers of general or specific businesses. This can get to be costly and many telephone customers find such directory assistance charges to be excessive.

There is also a current need for many businesses to market to a wide pool of consumers with targeted advertisement. This can be done efficiently through the use of SIC codes or “Standard Industry Codes.” By knowing exactly what a particular consumer is looking for at that particular moment a company can target their scope of interest with an ad.

The use of advertisements within a telephone system is well known in the art. U.S. Pat. No. 4,850,007 by Marino is for a “Telephone toll service with advertising”. It is a system for providing an economical telephone toll service in which a telephone subscriber selects the economical service by, for example, sending an appropriate signal, and then dials his directory assistance call or other telephone toll call. After the caller's options are determined, and typically before signaling for the call is commenced, a recorded-announcement of an aural or visual nature is connected to the subscriber's line, with the announcement consisting of at least one advertisement. The advertisements are selected from a databank according to some predetermined technique of selection, which may include any number of factors or features to make the service attractive to subscribers and of a nature to make the service also sufficiently rewarding to advertisers. The advertisement is not however, tied to the caller's specific interests or SIC code based on the number dialed.

U.S. Pat. No. 5,448,625 by Lederman is a “Telephone advertising method and apparatus.” It is a method and apparatus for routing a telephone call through a telephone network from a caller to a called party designated by the caller via advertising service apparatus that operates in two modes successively, the parties being in communication with each other in one mode and ads are selected from storage during that mode and the ads are impressed on one or both of the parties during a different mode. Selection of ad messages for use is controlled by many criteria. Delivery of the advertisements is recorded for accounting purposes. The modes may alternate between message intervals whose duration is determined by ad message length and communication intervals whose length is determined by a talking time timer. Still there is a need for better selection criteria.

U.S. Pat. No. 5,852,775 by Hidary is a “Cellular telephone advertising system.” It discloses a cellular telephone system, which is provided with an ad server and a memory for holding various commercial messages. The messages are either generic or are tailored for specific demographically selected subscribers or geographic cells. When communication is established either between a subscriber or a nonsubscriber, at least one of them receives either a generic or a specific commercial message. These advertisements are not geared to the needs of a particular caller.

U.S. Pat. No. 5,652,784 by Blen is an “Automatic telephone advertising provided in lieu of dial-tone.” This invention discloses a telephone advertising service providing a short advertising message through a telephone receiver as a telephone call is initiated. Several different messages are offered in different sets of channels, with the messages changing depending on the time of day. When a prohibit service signal is active, the subscriber line is switched directly to the telephone exchange. These messages are not targeted towards the interests of a particular caller.

There is still room for improvement within the art.

### SUMMARY OF THE INVENTION

It is a general object of the present invention to have a process that allows the cross marketing of phone customers when they ask for directory assistance.

The current invention is such that if a consumer is interested in airline tickets and they are calling Directory Assistance an ad based on their interest is played to that consumer. An airline or travel related ad will have a much higher impact and be received with a much higher level of interest with this consumer than to someone who is watching the evening news and is shown an airline ad.

By knowing exactly what a particular consumer is looking for at the moment they are looking; you can target their scope of interest with an ad. Using SIC code or “Standard Industry Code” or even some other variable such as having a live operator select which ad would be appropriate does this.

The concept is to use the information obtained in the 10 second listing request to play a targeted message and offer instant access to the product or service related to that message via “live call transfer” or “press 1 to be transferred to (the advertiser) now”.

For non-SIC code ads general, non-category specific ads such as “refinancing your home” or a home improvement ad can be played. These ads can be played based on the point of call. This can be done by setting up calls to be routed to a specific ad if the point of the caller's location is within a specific area code, zip code, city block or other parameter.

This would be helpful for companies like Home Depot, who might want to buy ad space in zip codes of “mostly owner occupied residences”, or pay day advance stores, who might want to buy advertisement for areas which are more economically depressed.

The type of ad and when the ad is played, can be controlled to a highly specific degree.

This system involves Point of call routing which is the routing an inbound 800 number call based on the location of the caller and routing the call to any predetermined location using zip code, area code, area code and prefix or city block maps.

Ads can be bought to target specific competitor names or industry codes. They can also be bought by markets delineated by zip code, area code city block or statewide.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a telephone toll system embodying the present invention;

FIG. 2 shows a block diagram of parts of the system involved with selecting the type of announcement connected to a particular subscriber's line;

FIG. 3 gives an example of Division Structure of SIC codes;

FIG. 4 gives an example of a Major Group of the SIC codes;

FIG. 5 is a schematic of the system; and

FIG. 6 gives a flowchart of the system.

### DETAILED DESCRIPTION OF THE INVENTION

A description of example embodiments of the invention follows.

### Preferred Embodiment

The preferred embodiment of the invention is a process that allows the cross marketing of phone customers asking for directory assistance.

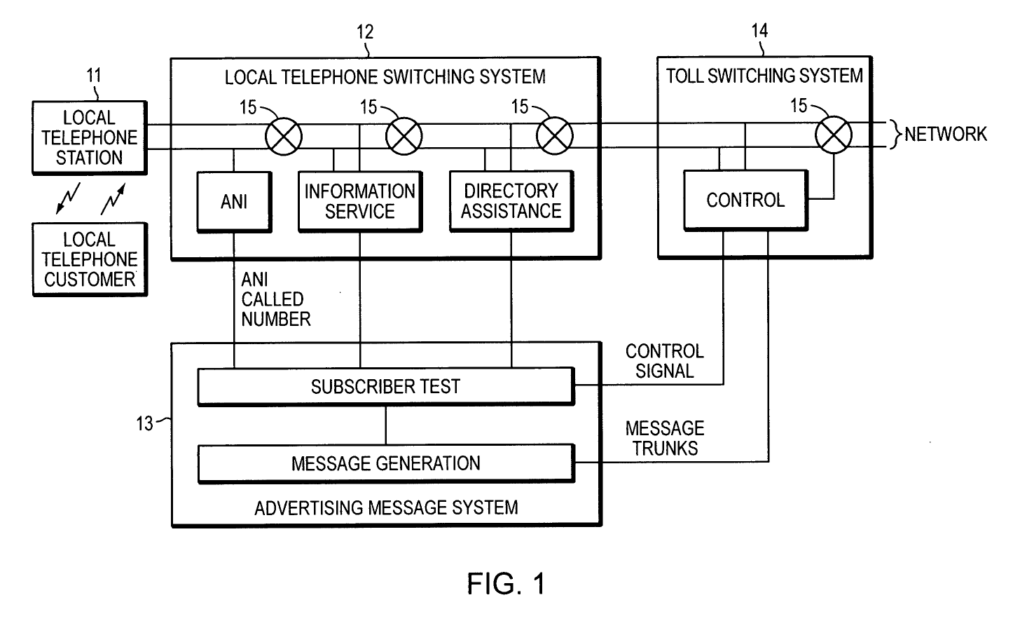

In FIG. 1, the local telephone station 11 is the typical telephone handset, in the usual case, and is connected by the typical local loop wires and connections to a local telephone switching system 12 which in turn connects through a toll switching system 14 to the total telephone network. Interconnected with the local telephone switching system 12 and the toll switching system 14 is the advertising message system 13 which is adapted to provide the directory assistance which has been generally summarized above.

In general, the local telephone station 11 is used by a local telephone customer, the User 10, indicated schematically.

The internal connections of the system are, in more detail, the following. The line from local telephone station 11 will be routed, through portions of switching elements 15, to the directory assistant module of the local switching system 12 if that is the nature of the customer's request, and in general, this may have been reached by dialing a specific phone number such as 1-800-Dealers.

It is anticipated that the broadest volume of use will result from long distance calling. The preferred embodiment will use a routing automatic number identification (ANI) within local telephone switching system 12, together with the subscriber test equipment in advertising message system 13, will identify the local customer in question as being one who wants to receive reduced directory assistance or long distance calling so that his incoming line will automatically be connected to advertising message system 13 before his toll call is completed.

In all of the foregoing situations identified in local telephone switching system 12, the result will be that a signal is sent to advertising message system 13 which results in a control signal being sent to toll switching system 12 to switching elements 16 to prevent the further progress of the user's call until the new features of this toll service have been provided. Therefore, at this point, the local telephone subscriber is not in contact with the larger telephone network.

In point of fact, this message may be of either an aural or visual nature, especially if the local subscriber has made available a monitor or television set connected to his telephone line. When this message ends, the control network within toll switching system 14 then removes the block on the signaling for the toll call and the call goes out over the network in the usual fashion.

The current invention is as follows if a consumer is interested in airline tickets RIGHT NOW and they are calling Directory Assistance the correct ad played to that consumer, an airline or travel related ad, will have a much higher impact and be received with a much higher level of interest than to someone who is watching the evening news and is shown an airline ad.

The system may examine the request for a specific provider of goods or services (i.e., the request is for an airline). From the request, the system then may infer that the caller also may be interested in another good or service (e.g., a “travel-related” service). This other good or service actually may be classified formally in another category, but is at least related in some way to the specific provider of goods or services. In other words, the system knows that callers interested in the first service are often also interested in the second service. From this inference, the system then plays an advertisement for the other good or service that is in a different, but related, category from the specific provider of goods or services.

For example, if a consumer requests information regarding a tow truck, an advertisement for an auto body shop may be played. Likewise, for a similar request for a tow truck, an advertisement for a personal injury attorney may be played. In these examples, the system makes inferences that consumers interested in tow trucks often are interested in auto body shops and personal injury attorneys, respectively, such as after a car accident. Further, if a consumer requests information regarding a movie theater, an advertisement for a restaurant near the theater may be played, or vice versa, with the common theme for inference being entertainment.

By knowing exactly what a particular consumer is looking for at the moment they are looking you can target their scope of interest with an ad. Using SIC code or “Standard Industry Code” or even some other variable such as having a live operator select which ad would be appropriate does this.

The concept is to use the information obtained in the 10 second listing request to play a targeted message and offer instant access to the product or service related to that message via “live call transfer” or “press 1 to be transferred to (the advertiser) now”.

For non SIC code ads general, non-category specific ads such as “refinancing your home” or a home improvement ad can be played. These ads can be played based on the point of call. This can be done by setting up calls to be routed to a specific advertisement if the point of the callers location is within a specific area code, zip code, city block or other parameter.

This would be helpful for companies like Home Depot, who might want to buy ad space in zip codes of “mostly owner occupied residences” or pay day advance stores which may want to purchase advertisement for areas that are more economically depressed.

The type of ad and when the ad is played can be controlled to a highly specific degree.

In the preferred embodiment the system will use Point of call routing, which is the routing of an inbound 800 number call based on the location of the caller and connecting that caller to any predetermined location using zip code, area code, area code and prefix or city block maps.

Ads can be bought to target specific competitor names or industry codes. They can also be bought by markets delineated by zip code, area code city block or statewide.

The advertisements could also have been chosen on a random basis, or they could have been chosen to provide sufficient exposure to each of the advertisers who provided the ads for this service. In any event these advertisements will be stored in a large-scale mass memory or memory means.

In all of the foregoing versions of the service, it should be apparent that the interactive logic could be extended to make it possible for the customer to indicate, e.g., by dialing appropriate digits, that he wishes written material to be sent to him or that he wishes to talk to a salesman—now or later.

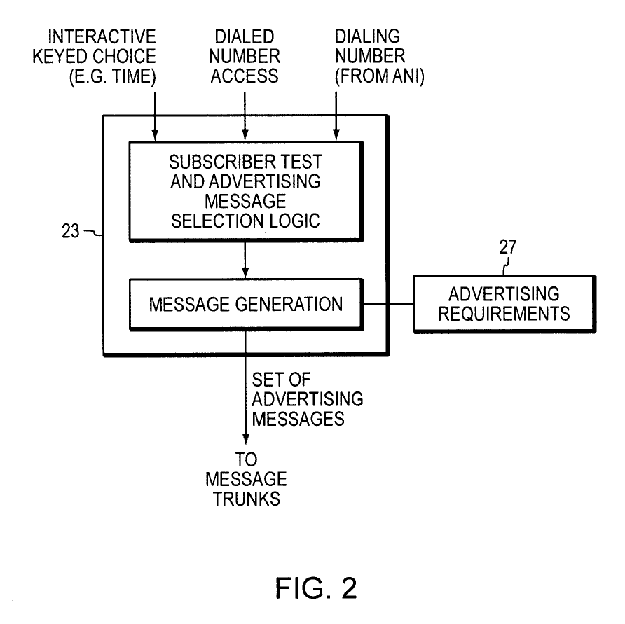

We have attempted to lay out in FIG. 2 a chart illustrating most of the foregoing message choice criteria in a logical manner.

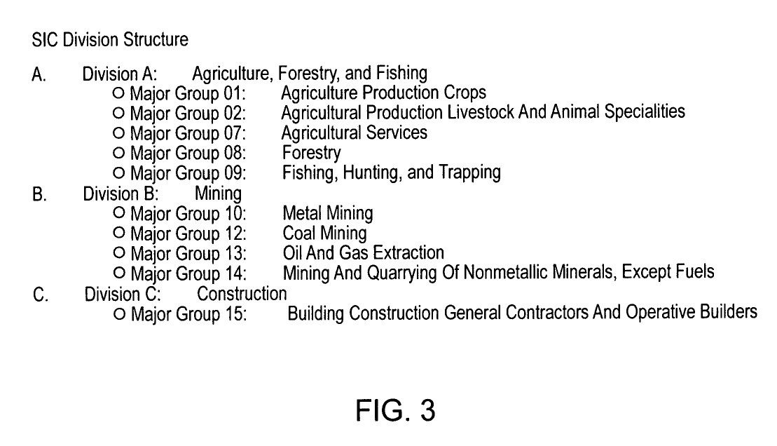

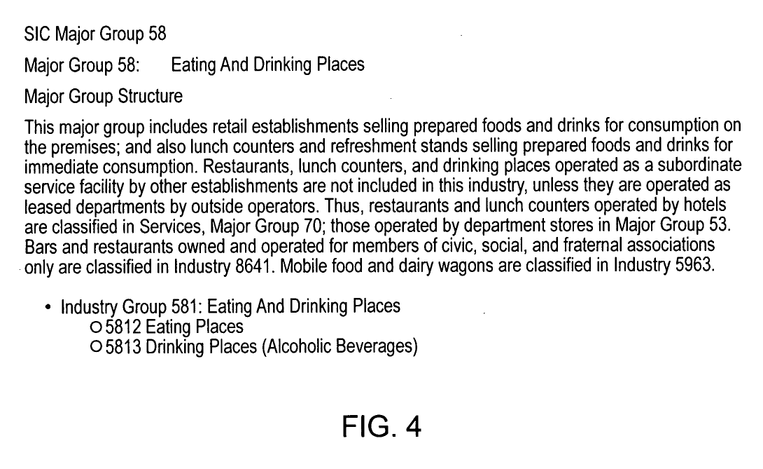

We have disclosed a sample of the SIC Division Structure in FIG. 3 and the SIC Major Group 58 in FIG. 4 to display the industry standard codes that can be used in the selection process.

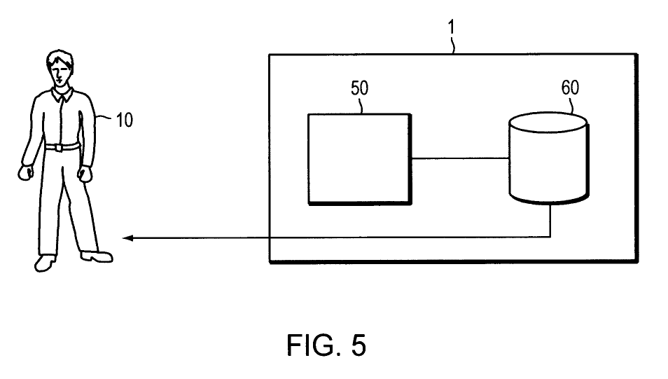

FIG. 5 is a schematic of how system 1 works. The User 10 calls and is connected to a directory assistance number. The User 10 requests a number or a type of service or good, the system uses this as part of the selection criteria which is used by a selection means 50 such as a computer processor and selects an advertisement from the database 60 and the advertisement is played back to the User 10.

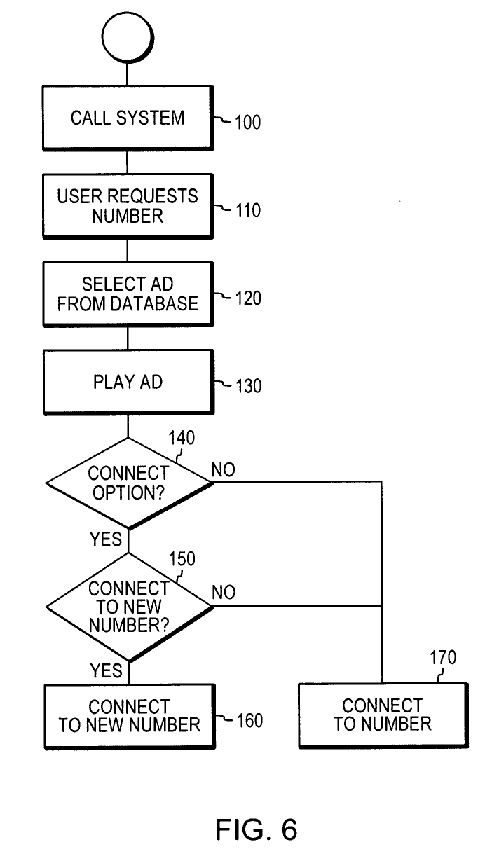

FIG. 6 is a basic flowchart of the process. In Step 100, the User 10 calls the system 1. The User 10 then requests a specific number of a company or a type of goods or services in Step 110. The system 1 uses the request, along with additional information such as the locations from where call was placed and other targeting information to select an ad from the advertising database 60 in step 120. The system 1 retrieves the ad and plays it for the User 10 in step 130. In step 140, the system 1 asks “is there a connection option for this ad?” If yes, the User 10 is asked if they want to opt to be connected to the advertiser's number 150. If yes, the User 10 is connected to the advertiser's number 160. If no, the User 10 is connected to their selected number 170. If there is no connection option for this ad, the User 10 is connected to their selected number 170.

### Additional Embodiment

This system could also be used in a wireless environment with Handheld PCs or an Internet or chat environment.

### Advantages

The current invention provides much needed inexpensive directory assistance. The user calls a unique number for directory assistance, an operator answers that call and asks the user of his/her desired phone number, the system then uses this phone number as one of the basis for the selection criteria to select an advertisement for the system to play for the user. After the user listens to the advertisement, the system will provide the user with the desired phone number. The system may have the option for the user to select on or contact another company for the service.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for providing directory assistance information in a public telecommunication network, the network comprising a customer station and a call processing station, the method comprising:
at the customer station;
dialing a telephone number used for accessing the call processing station;
setting up a call connection from the customer station to the call processing station;
providing a request for information relating to a specific provider of goods or services;
at the call processing station;
receiving the request for information from the customer station;
examining the request for information to identify a category associated with the specific provider of goods or services;
selecting an advertisement categorized within a category related to the identified category;
retrieving the selected advertisement from a stored media;
forwarding the selected advertisement to the customer station; and
at the customer station, receiving the selected advertisement.

2. The method of claim 1, further comprising:
querying a database to determine the selected advertisement, the querying using as at least one query parameter from the examining the request for information.

3. The method of claim 2, wherein the query parameter is a geographic location component of the specific provider of goods or services in the request for information.

4. The method of claim 2, wherein the query parameter is a name of a business that is the specific provider of goods or services.

5. The method of claim 2, wherein the query parameter is a general type of business associated with the specific provider of goods or services specified in the request for information.

6. The method of claim 2, wherein the query parameter is a description of a product or service.

7. The method of claim 2, wherein the query parameter is the telephone number associated with the specific provider associated with the request for information.

8. The method of claim 7, wherein the query parameter is a Standard Industry Classification (SIC) code associated with the telephone number associated with the specific provider.

9. The method as in claim 1, wherein the request for information relating to a telephone number for a specific provider of goods or services does not inherently determine the category.

10. A system for providing access to directory assistance information for a public network via a toll-free number, the system comprising:
a customer station including call connection circuitry; and
a call processing station that operates to receive a request for directory assistance information from the customer station, examine the request for directory assistance information to identify a category associated with a specific provider of goods or services, select an advertisement categorized within a category related to the identified category and selectively forward the selected advertisement to the customer station.

11. The system of claim 10, the customer station further comprising:
a user input device to obtain a telephone number used for accessing the call processing station;
a transmitter that operates to transmit the request for directory assistance information received from the user, wherein the call connection circuitry operates to set up a call connection from the customer station to the call processing station via the toll-free number; and
a first a receiver that operates to receive the selected advertisement.

12. The system of claim 10, the call processing station further comprising:
a second receiver that operates to receive the request for directory assistance information from the customer station; and
a processor that operates to retrieve the selected advertisement from a stored media.

13. The system of claim 10, further comprising:
a database apparatus that operates to process a query to determine the selected advertisement, the query having at least one query parameter derived from the request for directory assistance information.

14. The system of claim 13, wherein the query parameter is a name of a business that is the specific provider of the goods or the services.

15. The system of claim 13, wherein the query parameter is a description of a good or service.

16. The system of claim 13, wherein the query parameter is the telephone number associated with the specific provider associated with the request for directory assistance information.

17. The system of claim 16, wherein the query parameter is a SIC code associated with the telephone number associated with the specific provider.

18. The system of claim 13, wherein the processing station further selects the advertisement based on a telephone number requested by the user.

19. The system of claim 10, wherein the request for directory assistance information relating to a telephone number for the specific provider of the goods or the services does not inherently determine the category.
